(19) United States
(12) Patent Application Publication
(10) Pub. No.: US 2006/0259166 A1
(43) Pub. Date: Nov. 16, 2006

(54) Intelligent interface for connecting sensors to a network

(75) Inventors: Philip M. Hoffman, Colonial Beach, VA (US); David D. Cochran JR., Mechanicsville, VA (US)

Correspondence Address: ROBERTS, MARDULA & WERTHEIM, LLC, 11800 SUNRISE VALLEY DRIVE, SUITE 1000, RESTON, VA, 20191, US

(73) Assignee: Sentel Corporation

(21) Appl. No.: 11/127,977

(22) Filed: May 12, 2005

(51) Int. Cl. G05B 19/18; G05B 9/02; G05B 15/00

(52) U.S. Cl. 700/80; 700/83; 700/82; 700/65; 700/66

(57) ABSTRACT

A micro remote data relay receives sensor data from disparate sensors and determines locally whether an alarm condition has occurred. A state machine manages device configuration, memory allocation and usage, algorithm processing of sensor data, and communications. Alarm condition algorithms use data from single sensor or multiple sensors to determine whether an alarm condition has occurred. Sensor data is stored locally. A subset of sensor data and alarm condition reporting is sent to a remote data relay command post allowing monitoring of a perimeter while minimizing data transmission and network usage.

### BACKGROUND

Embodiments of the present invention are generally directed to providing remotely located sensors in a network. More particularly, embodiments of the present invention provide a system and method for using a single interface to interconnect disparate remote sensors via a network.

Networks of remote sensors are used to monitor emissions from manufacturing facilities, to provide security around homes, military facilities, commercial establishments, and to monitor conditions in battle zones. A networked array of sensors may be monitored and operated from a central command post, a capability that minimizes any requirement to use human resources to monitor and operate sensors.

Connection to the sensors is typically accomplished through radio modem or via an Ethernet connection. A personal computer provides processing and connectivity capabilities to the sensor network. Data is stored on a hard drive. An operating system, such as Windows® operating system, manages tasks assigned to the sensor network. Power is provided to the computer, sensors, and radio modem from a utility power line, to a 12-V or 24-V battery pack.

While such systems have proved useful, for many applications the systems are expensive to acquire and maintain. Mechanical hard drives fail when exposed to large variations in temperature and humidity and to physical shock. The computers used to support these systems draw a significant amount of power. Additionally, many of the systems are designed to report sensor data to a central location for processing and a determination whether further action is desirable at a monitored location. The need for action is then reported back to the monitored location. A response at the monitored located to a detected risk is thus dependent on the availability of the network and the hardware and software at the central location. A failure of the network or the facilities at the central location could have significant consequences.

As noted above, processing is provided by a personal computer. Using a personal computer for processing simplifies the overall design of the local plant and provides sufficient computing power to manage large networks of sensors. However, the tradeoff for design simplicity is physical size and power consumption. Additionally, in many applications, the number of sensors desirable is less than the design capacity of the personal computer resulting in underutilization of the computer's resources without a concomitant savings in size or power requirements.

What would be useful would be a compact, energy efficient sensor interface that provides connectivity to disparate sensors and provides local automated command of sensors in response to a detected risk.

### SUMMARY

An embodiment of the present invention uses a micro remote data relay (MRDR) comprising an intelligent sensor interface, a processor, a storage device for data collection, a storage device for software storage and a network interface for integrating remote sensors and devices into a single network. One or more MRDRs are connected to a remote data relay command post (RDR/CP) software application which is used to monitor and control the remote devices. In an embodiment of the present invention, the sensors comprise chemical, biological, radiological and nuclear (CBRN) sensors, meteorological sensors, full-motion video cameras, motion detectors, ground surveillance radars, and pan/tilt/zoom camera mounts.

In an exemplary embodiment of the present invention, the sensor interface provides analog, digital, serial, and Ethernet ports for compatible sensors and devices. Data archiving is provided by means of an internal compact flash memory device, although this is not meant as a limitation. Other memory types will also be useful in the present invention. While the MRDR may be controlled by the RDR/CP, the processor of the MRDR can perform remote algorithmic control operations, and provides for efficient communication. The network interface provides connectivity to a network via a radio modem, a hardwired LAN, or a wireless LAN. A data reduction algorithm reduces the amount of data that is conveyed to the RDR/CP by pre-processing the data at the MRDR.

It is therefore an aspect of the present invention to integrate disparate sensors into a network using a MRDR.

It is another aspect of the present invention to provide an MRDR that is designed to withstand environmental stresses.

It is still another aspect of the present invention to implement an MRDR that uses memory management techniques to minimize the on-board memory required to operate a network of sensors and to gather and process data from the networked sensors.

It is yet another aspect of the present invention to provide processing resources at the MRDR so as to make local determinations whether sensor data is indicative of a alarm conditions and to take local actions in response to an alarm condition.

It is yet another aspect of the present invention to communicate with an MRDR from a remote data relay command post to obtain sensor data and determine whether an alarm condition has occurred.

It is an aspect of the present invention to pre-process sensor data at an MRDR so as to manage the data traffic between the MRDR and a remote data relay command post.

These and other aspects of the present invention will become apparent from a review of the general and detailed descriptions to follow.

According to an embodiment of the present invention, a micro data relay comprises a storage device, a sensor interface that receives sensor data from an electronic sensor, and a state machine comprising a processor and instructions stored in a memory. In an embodiment of the present invention, the memory is a flash memory and device configuration information is stored in sectors 0 and 1 of the flash memory.

In another embodiment of the present invention, the electronic sensor is selected from the group consisting of a chemical sensor, a biological sensor, radiological sensor, a nuclear sensor, meteorological sensor, a full-motion video camera, a motion detector, a ground surveillance radar, and pan/tilt/zoom camera mount.

The state machine determines a memory block size for the sensor data, allocates a memory block equal to the memory block size in the storage device, initializes the electronic sensor with device configuration information, receives sensor data from the sensor interface, and processes the sensor data to determine if an alarm condition has occurred. According to an embodiment of the present invention, device configuration information is selected from the group consisting of an algorithm, a variable value, a memory pointer, a callback function pointer, a micro data relay identifier, and a port identifier.

In still another embodiment of the present invention, the micro data relay further comprises a network interface that connects the micro data relay to a data relay command post. The state machine sends sensor data to the data relay command post.

Another embodiment of the present invention provides a method of integrating remote sensors into a network. A memory block size of sensor data generated by an electronic sensor is determined. A memory block equal to the memory block size is allocated in a storage device. In an embodiment of the present invention, the storage device is a flash memory and device configuration information is stored in sectors 0 and 1 of the flash memory. In yet another embodiment of the present invention, device configuration information is selected from the group consisting of an algorithm, a variable value, a memory pointer, a callback function pointer, a micro data relay identifier, and a port identifier.

The electronic sensor is initialized with device configuration information. Sensor data is received from the electronic sensor and processed to determine if an alarm condition has occurred. In another embodiment of the present invention, the electronic sensor is selected from the group consisting of a chemical sensor, a biological sensor, radiological sensor, a nuclear sensor, meteorological sensor, a full-motion video camera, a motion detector, a ground surveillance radar, and pan/tilt/zoom camera mount.

In another embodiment of the present invention, the method further comprises sending sensor data to the data relay command post.

### DESCRIPTION OF THE FIGURES

FIG. 1 illustrates a system of micro remote data relays under the control of a remote data relay command post according to an embodiment of the presenting invention

FIG. 2 illustrates the logical components of a micro remote data relay (MRDR) according to an embodiment of the present invention.

FIG. 3 illustrates a block diagram of a task manager implemented in random access memory 210 according to an embodiment of the present invention.

### DETAILED DESCRIPTION

An embodiment of the present invention uses a micro remote data relay (MRDR) comprising an intelligent sensor interface, a processor, a storage device for data collection, a storage device for software storage and a network interface for integrating remote sensors and devices into a single network. One or more MRDRs are connected to a remote data relay command post (RDR/CP) software application which is used to monitor and control the remote devices. In an embodiment of the present invention, the sensors comprise chemical, biological, radiological and nuclear (CBRN) sensors, full-motion video cameras, meteorological sensors, motion detectors, ground surveillance radars, and pan/tilt/zoom camera mounts.

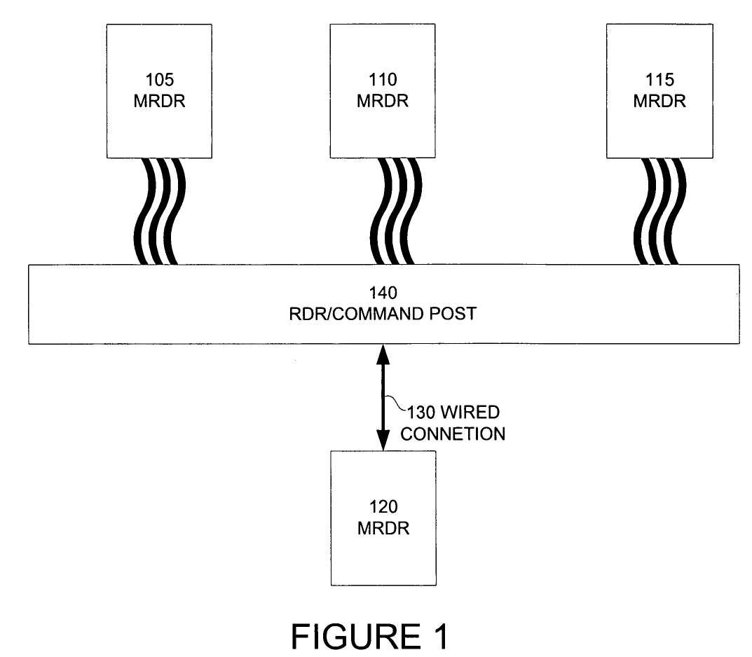

FIG. 1 illustrates a system of micro remote data relays under the control of a remote data relay command post according to an embodiment of the presenting invention. Micro remote data relays (MRDRs) 105, 110, 115 communicate over wireless links to remote data relay command post (RMR/CP) 140. MRDR 120 communicates with RMR/CP 140 via wired connection 130.

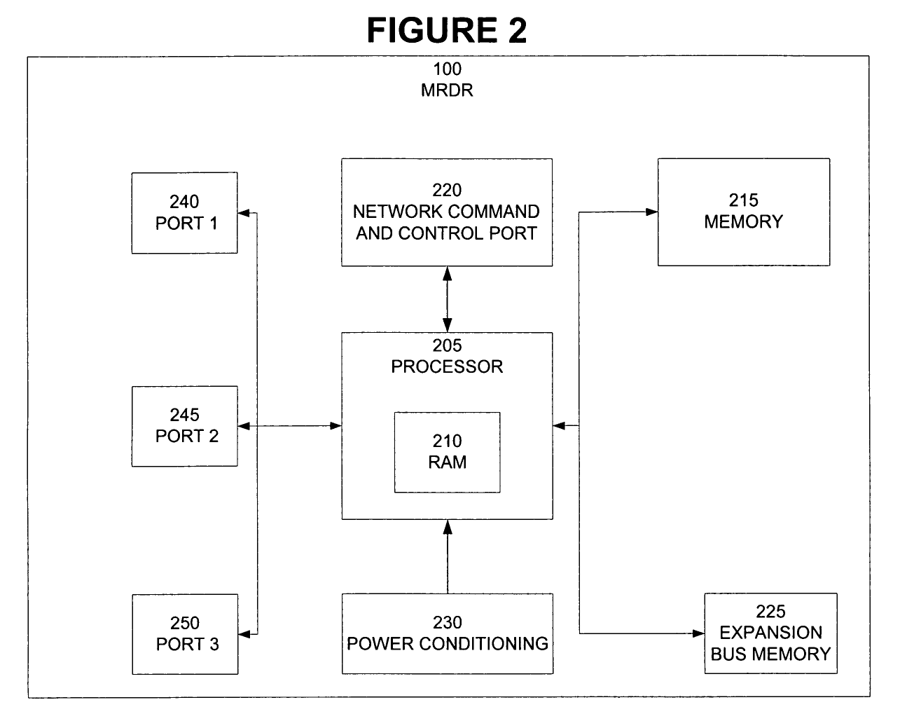

In an embodiment of the present invention, MRDRs 105, 110, 115 send data to, and receive data, from the RDR/CP 140. These data include commands to configure connected devices, reporting of connected device status, and control messages for connected devices attached to an MRDR (105, 110, 115). In an embodiment of the present invention, an MRDR (105, 110, 115) is connected to multiple sensors and devices and integrates them into a cohesive network (see FIG. 2). The communication interface between an MRDR and the individual devices allows the use of disparate devices. Thus, any device that can output data through a standard port and any device that can be identified as a network device can be included in an MRDR—MRDR/CP network. By way of illustration and not as a limitation, the MRDR gathers data from chemical, biological, radiological and nuclear (CBRN) sensors, meteorological sensors, full-motion video cameras, motion detectors, ground surveillance radars, and pan/tilt/zoom camera mounts.

FIG. 2 illustrates the logical components of a micro remote data relay (MRDR) according to embodiments of the present invention. Referring to FIG. 2, an embodiment of the present invention comprises a micro remote data relay (MRDR) 200 comprising a processor 205, local RAM 210, a memory 215, a network command control port 220, an expansion bus 225, power conditioning module 230, and ports 1, 2, and 3 (240, 245 and 250).

Data is saved in memory 215. In an exemplary embodiment of the present invention, memory 215 is a flash memory device connected via a compact flash/IDE interface. As will be appreciated by those skilled in the art, other types of memory may be utilized without departing from the scope of the present invention. In an embodiment of the present invention, sectors 0 and 1 of memory 215 have been reserved for configuration data to include items such as IP address, device configuration, algorithm selection, and data archive settings. In an embodiment of the present invention, the two configuration sectors are mirrored to ensure the integrity of the configuration information. Both configuration sectors are read at startup and compared to stored checksums and to each other before the configuration information is used to configure the MRDR. Configuration of the hardware components of the MRDR 200 is discussed in detail below.

In an embodiment of the present invention, ports 240, 245 and 250 are standard serial ports, however this is not meant as a limitation. As will be appreciated by those skilled in the art, other ports may be defined without departing from the scope of the present invention. By way of illustration and not as a limitation, in an embodiment of the present invention, port 1 240 is a USB port. In an alternate embodiment of the present invention, port 1 240 is a parallel port.

In an exemplary embodiment of the present invention, the network command and control port 220 is an Ethernet port. In this embodiment of the present invention, the Ethernet port is configured to use the Internet protocol (IP) and the port is connected to a local area network.

Expansion bus 225 provides connection to analog and digital devices. By way of illustration and not as a limitation, analog sensors and digital sensors may be connected to expansion bus 225 and controlled by the MRDR.

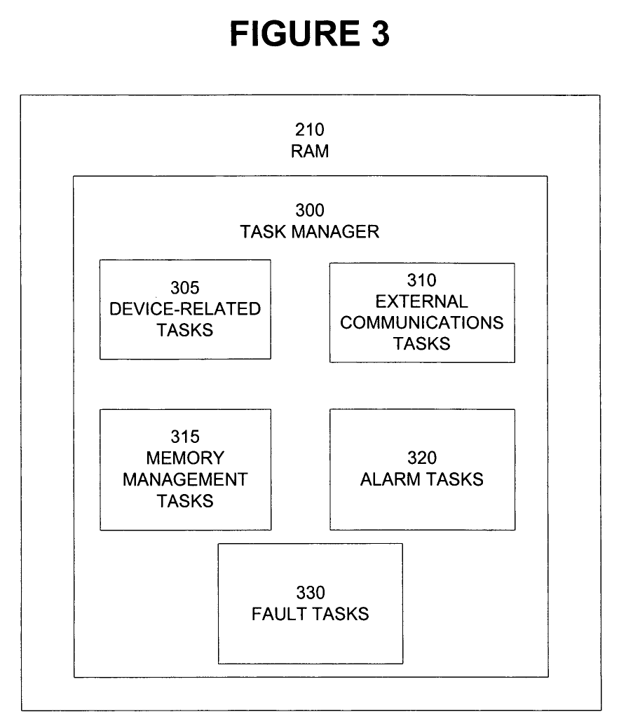

In an exemplary embodiment of the present invention, processor 205 does not utilize an operating system. Rather, the tasks normally performed by an operating system are managed by software stored in local RAM 210. FIG. 3 illustrates a block diagram of a task manager implemented in random access memory 210 according to an embodiment of the present invention. In this embodiment of the present invention, a state machine is implemented to manage a “TASK” process. Devices are provided with TASK space as well as algorithms, or other process helpers that have tasks to perform. The following Program Design Language (PDL) sample illustrates an implementation of a state machine according to an embodiment of the present invention:

```
INITIALIZE PERMANENT TASKS
      INITIALIZE CONFIGURATION MODULE
      INITIALIZE EXTERNAL COMMUNICATIONS MODULE
      INITIALIZE ALARM MODULE
      INITIALIZE FAULT MODULE
CONFIGURE DEVICES
START THREADS
      EXTERNAL INTERFACE CHANGE ADDRESS
      EXTERNAL COMMUNICATIONS INTERFACE
            READ MESSAGES
            PARSE MESSAGES
            SEND MESSAGES
      CONFIG MANAGER ADD/REMOVE
            ADD/REMOVE DEVICES/PROCESSES
      ALARM MANAGER
            EVALUATE INDIVIDUAL DEVICE ALARMS
      DEVICE PROCESS TASK 1..n
            GID3 CHEMICAL SENSOR INTERFACE - PORT 1
            :
            :
      PROCESS TASK n
END THREADS
```

Each task within the MRDR is responsible for maintaining a task data structure that manages the task memory usage and process flow. By way of illustration and not as a limitation, an embodiment of the present invention uses a task data structure as follows:

| STRUCT TASK_DATA | |
|---|---|
| { | |
| CHAR | PROCESS_NAME; |
| VOID* | PROCESS_DATA; |
| FP* | Init_Function(INT* ProcessData); |
| FP* | Run_Functions[n](INT* ProcessData); |
| FP* | ActionCallBack(INT* ProcessData, char* Message); |
| FP* | Exit_Function(INT* ProcessData); |
| Int | NumberOfRunFunctions; |
| }; | |

In this exemplary structure, pointers to the process specific functions are used to implement the process interface. Additionally, there is a pointer to the individual process data for each task. This is desirable for the implementation of re-entrant functions that access process/device specific data.

In this embodiment of the present invention, each device has a set of “Run” functions that are looped through for the entire life of the device. These functions are arranged in the form of an array so that all devices are able to have their own specific functions without imposing their requirements on other devices. The only requirement for all devices is that they utilize an “Init” function to assign memory pointers and specify the “Run Functions”, they manage their memory wisely during the “Run” functions, and their “Exit” function cleans up all memory used.

In an alternate embodiment of the present invention, a multitasking tool eliminates the need for the RunFunctions array.

Each task within the MRDR utilizes memory to perform its tasks. Since the MRDR has limited memory allocation capabilities, strict rules governing the allocation and deallocation of memory are used. In most cases device, memory allocations are performed at the main program level, and are allocated in block sizes that are as large or larger than the amount of memory needed for the current device list. This is done to prevent fragmentation of the memory. Every function call within the device architecture also passes a data memory pointer to allocate memory to multiple devices without having to worry about memory sharing. For example, if the user wishes to communicate with three devices, three memory blocks are allocated, one for each device to be communicated with.

The state machine performs the various functions assigned to MRDR 100 through defined tasks. Referring to FIG. 3, a task manager 300 comprises software modules responsible for performing device-related tasks 305, external communications tasks 310, memory management tasks 315, alarm management tasks 320, and fault management tasks 330.

### A. DEVICE-RELATED TASKS

At the outset, the MRDR is initialized to an operational state and configured by specifying which devices are connected to it and to what port. A device initialization task within device-related tasks module 305 reads configuration data from memory 215 upon startup. Subsequently, a device management task within device-related tasks module 305 runs in parallel with an external communications task (described below) to provide device configuration events from an external communications interface.

Device-related tasks module 305 also provides an external interface the capability to configure the MRDR to communicate with specified devices. In an embodiment of the present invention, this interface is implemented through the communications interface with the RDR/CP.

Initialization of a device configuration module is accomplished by reading the configuration sectors from the memory 215 (ReadConfigData). In an embodiment of the present invention, memory 215 is a compact flash memory and the configuration sectors are defined as sectors 0 and 1. These sectors are checksum validated to ensure that configuration data is not compromised due to a failure of the compact flash data storage device. The configuration data comprises the configuration of the MRDR in its last known state.

In an embodiment of the present invention, a configuration manager within device-related tasks module 305 supports a callback function (ConfigCallback) that is called by an external communications module to provide for the configuration of devices through the RDR/CP interface.

Configuration of devices connected to the MRDR is performed using an RDR/CP connected to the MRDR and communicating through an external communications module within external communications task module 310. The external communications module passes device configuration events into a configuration manager through the ConfigureCallback function. The configuration manager is responsible for maintaining a list of available device interfaces that are provided to the RDR/CP through the external communications module. It is also responsible for stopping a device that is currently running, and re-configuring the selected port for a new device if the device is within its inventory of available device interfaces.

Devices are responsible for performing initialization operations to include the initialization of all algorithms and variables used. Device initialization also stores the Callback function pointers, MRDR Serial Number, Port identification, and any other item necessary for the construction of Interface Messages and the processing of the data interface. Some of these items may also be stored as part of a “MessageHelper” module that assists with the formation of RDR/CP messages.

### B. EXTERNAL COMMUNICATIONS TASKS

An external communications tasks module 310 performs task directed to providing connectivity for the MRDR. As part of this process the external communications tasks module 310 performs the following tasks:

External Interface Initialization

External Interface Message Read

External Interface Message Parse

External Interface Message Output

The external communications tasks module 310 comprises a queue manager that provides AddMessage, ExtractMessage, RemoveMessage, and ResetQueue functions. The external communications tasks module 310 also provides a MessageManager that provides MessageInit, MessageAppend, MessageChecksum, and MessageClear functions to assist with the construction of RDR/CP Messages.

In an embodiment of the present invention, an external interface comprises a TCP/IP interface for communications to an RDR/CP, thereby permitting the MRDR to operate either in DHCP mode, or Static IP model. In this embodiment, initialization of the external interface comprises allocation of IP Address Configuration, Port Allocation, Input and Output Message Buffers, and the creation of the Output Message Queue. The IP Address for the MRDR is stored in the configuration sectors on the MRDR memory 215 and is read during initialization to provide for Ethernet initialization. If the MRDR has not been configured to communicate with an RDR/CP, the IP Address stored in the configuration is “0.0.0.0”. The message buffers are dynamic global character arrays that are created and used for buffered reads and writes providing for a more efficient use of the Ethernet Interface. The Output Message Queue is a “First-In-First-Out” (FIFO) message Queue that is utilized by the device interfaces within the MRDR for communicating alarms and status to the RDR/CP. In the event that external communications are not enabled, the RDR will continue to operate as previously configured.

The external communications tasks module 310 is also responsible for reading messages from a configured network command and control port 220. In an exemplary embodiment of the present invention, the network command and control port 220 is an Ethernet port. The Messages are read into an external communications input buffer. These messages are validated using checksum calculation routines provided by RDR/CP. Once validated messages are cleared from the incoming queue, they are passed to the appropriate handlers through task action callback functions.

The external communications tasks module 310 is also responsible for writing messages to the configured Ethernet port 220. Messages are constructed and validation checksums generated. Messages are sent to the outgoing TCP/IP message queue are sent from TCP/IP port. If an acknowledgment (ACK) is received from the RDR/CP, a message is removed from the outgoing message queue. Acceptable timeouts and retries are implemented for all messages placed in the queue.

### C. MEMORY MANAGEMENT TASKS

Memory management tasks module 315 is responsible for performing tasks relating to memory allocation and utilization. In an exemplary embodiment of the present invention, memory 215 is a compact flash data storage device that is connected through a compact flash IDE Interface 215. Compact flash devices provide the MRDR with a miniature shock resistant storage medium. Because compact flash data storage devices have a limited number of write operations that may occur to each sector, the MRDR data archive functions treat the entire media (minus the configuration sectors) as circular queue. Data are written to the media from beginning to end and back to the beginning again. This technique spreads the write functions across all sectors. Current values of the “Head” and “Tail” of the compact flash data archive queue are stored in local RAM 210. Each data archive block also contains a header that provides data block information regarding message extraction data.

In an embodiment of the present invention, each device reports the size memory block it requires prior to initialization of the device. This function (GetMinMemoryBlockSize) provides the MRDR state engine means for allocating memory in blocks for all devices regardless of the structures used by each device. The pointer to these memory blocks are passed to the device initialization function, and the device casts this memory pointer to the data structure to be used by the device module.

Each device initializes the port specified as part of the device initialization and read data based on the information in the device specific interface specification. This data is then be parsed by a parse routine built specifically for each device. In an embodiment of the present invention, this parse routine extracts the following types of information for further processing:

Fault/BIT Status Information

Alarm Information

Device Raw Data (for data archive use)

Connection Status

Data Logging Status (provides for user control or data archival)

Typically, the data collected by a connected device is more than necessary to perform the task assigned to that device. In an embodiment of the present invention, the memory management tasks module 310 extracts and forward a subset of the collected data to the RDR/CP. A second subset of data is stored on a compact flash data storage device for later retrieval. By way of illustration and not as a limitation, a second subset of data comprises raw sensed data, software initiation data, device configuration data, and alarm event data.

### D. ALARM TASKS

An alarm tasks module 320 is responsible for determining the presence of alarm states and taking appropriate actions based on those states. The alarm tasks module 320 maintains a current list of the alarmed sensors and uses this information and the currently selected alarm algorithm to make a determination as to whether the MRDR is in an alarmed state. Initialization of the alarm tasks module 320 comprises module initialization to include the passing of the Callback functions to all currently configured sensors and the initialization of all module variables and default algorithm settings acquired during the configuration initialization.

Alarm states are determined via user-set algorithms. For example, if more than one chemical sensor is connected to an MRDR, an alarm may not be declared unless all chemical sensors are in an alarm state. Or if a biological sampler and/or identifier is connected to an MRDR, the MRDR can be set to take a sample only if a trigger event occurs (e.g., a particle counter trigger). Because algorithms can be set and stored locally at each MRDR, units can be configured to operate standalone, without interconnectivity to RDR/CP software. When operating with the RDR/CP software, the ability of MRDRs to operate autonomously has the added benefit of enabling the continued operation of local MRDR sensor suites in the event of loss of connectivity to the RDR/CP.

### E. FAULT MANAGEMENT TASKS

Fault management tasks module 330 is responsible for determining whether a message sent to the RDR/CP was received without corruption. In an embodiment of the present invention, transmitted data is fault tolerant and is automatically resent if it is not properly received. In an embodiment of the present invention, fault management tasks module 330 determines whether an “ACK” message is received from the RDR-CP in response to a message sent by the MRDR. If the “ACK” message is received by the MRDR, the sent message is removed from the outgoing message queue. In yet another embodiment of the present invention, fault management tasks module 330 defines acceptable timeouts and retries that will be implemented for all messages placed in the message queue.

An intelligent interface for connecting sensors to a network has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

1. A micro data relay comprising:
a storage device;
a sensor interface, wherein the sensor interface is adapted to receive sensor data from an electronic sensor; and
a state machine comprising a processor and instructions stored in a memory, wherein the state machine is adapted to:
determine a memory block size for the sensor data;
allocate a memory block equal to the memory block size in the storage device;
initialize the electronic sensor with device configuration information;
receive sensor data from the sensor interface; and
process the sensor data to determine if an alarm condition has occurred.

2. The micro data relay of claim 1, wherein the storage device is a compact flash memory.

3. The micro data relay of claim 2, wherein device configuration information is stored in sectors 0 and 1.

4. The micro data relay of claim 1, wherein device configuration information is selected from the group consisting of an algorithm, a variable value, a memory pointer, a callback function pointer, a micro data relay identifier, and a port identifier.

5. The micro data relay of claim 1, wherein the device configuration information comprises an algorithm and where the algorithm determines if an alarm condition has occurred based on sensor data from a plurality of sensors.

6. The micro data relay of claim 5 wherein the micro data relay further comprises a network interface and wherein the network interface is adapted to connect the micro data relay to a data relay command post and wherein the state machine is adapted to send sensor data to the data relay command post.

7. A method of integrating remote sensors into a network comprising:
determining a memory block size of sensor data generated by an electronic sensor;
allocating a memory block equal to the memory block size in a storage device;
initializing the electronic sensor with device configuration information;
receiving sensor data from the electronic sensor; and
processing the sensor data to determine if an alarm condition has occurred.

8. The method of integrating remote sensors into a network of claim 7, wherein the storage device is a compact flash memory.

9. The method of integrating remote sensors into a network of claim 8, wherein device configuration information is stored in sectors 0 and 1.

10. The method of integrating remote sensors into a network of claim 7, wherein the electronic sensor is selected from the group consisting of a chemical sensor, a biological sensor, radiological sensor, a nuclear sensor, a full-motion video camera, a motion detector, a ground surveillance radar, and pan/tilt/zoom camera mount.

11. The method of integrating remote sensors into a network of claim 7, wherein device configuration information is selected from the group consisting of an algorithm, a variable value, a memory pointer, a callback function pointer, a micro data relay identifier, and a port identifier,

12. The method of integrating remote sensors into a network of claim 7, wherein the device configuration information comprises an algorithm and where the method further comprises determining if an alarm condition has occurred using sensor data from a plurality of sensors.

13. The method of integrating remote sensors into a network of claim 12, wherein method further comprises sending sensor data to the data relay command post.
